(19) United States
(12) Patent Application Publication
(10) Pub. No.: US 2006/0069744 A1
(43) Pub. Date: Mar. 30, 2006

(54) Method and system for transmitting information through multiple communication channels

(76) Inventors: Enrica Alberti, Roma (IT); Salvatore D'Alo, Roma (IT); Alessandro Donatelli, Roma (IT); Luigi Pichetti, Roma (IT); Alessandro Scotti, Roma (IT)

Correspondence Address: IBM CORPORATION;INTELLECTUAL PROPERTY LAW, 11400 BURNET ROAD, AUSTIN, TX, 78758, US

(21) Appl. No.: 11/217,865

(22) Filed: Sep. 1, 2005

(30) Foreign Application Priority Data
Sep. 1, 2004 (EP) 04104183.1

(51) Int. Cl. G06F 15/16

(52) U.S. Cl. 709/217

(57) ABSTRACT

A method for transmitting information (from a source computer to one or more target computers) is proposed. The solution of the invention applies to a message (300o) that includes a main body (310) with possible attachments (315), each one identified by a corresponding internal link (320i) The attachments including bulk data are removed and placed onto a location (125s) of a distribution service wherein they are available for downloading; at the same time, the internal links of the removed attachments are replaced with external links (320e), which point to the corresponding downloading locations. The resulting compacted message (300c) is transmitted to each target computer directly. The target computer downloads the desired removed attachments (from the locations pointed by the corresponding external links); the message can then be reconstructed by restoring the downloaded attachments.

### TECHNICAL FIELD

The present invention relates to the data processing field. More specifically, the present invention relates to a method of transiting information in a data processing system with distributed architecture. The invention further relates to a computer program for performing the method, and to a product embodying the program. Moreover, the invention also relates to a corresponding data processing system.

### BACKGROUND ART

Distributed data processing systems have become very popular in the last years, especially thanks to the widespread diffusion of the Internet. Those systems involve the exchange of an enormous amount of information between different computers; typical examples are the sending of e-mails, the distribution of software packages, the downloading of web pages, and the like.

Several solutions have been proposed in an attempt to improve the above-mentioned process.

For example, in an e-mail system each message consists of a main body with possible attachments. In this case, some commercially available products (such as “Lotus cc-mail” by IBM Corporation) allow receiving the attachments on-demand. Particularly, once the message has been loaded onto a mail server only its body is transmitted to a computer of the corresponding addressee (while any attachments are left on the mail server); in this case, the addressee can select and download the desired attachments at will. The proposed solution allows the addressee to check its e-mail without overloading a communication channel between the mail server and the addressee's computer. However, this solution only postpones the downloading of the attachments, but it does not approach in any way the problem of optimizing the transmission of the message. Moreover, the above-mentioned method always requires the transmission of the whole message to the mail server.

Another approach has been proposed for transmitting documents when alternative communication channels are available between a source computer and each target computer (for example, a short-message service, a facsimile service and an e-mail service). In this case, the source computer automatically selects the preferred communication channel according to characteristics of the document to be transmitted (such as its size). This solution allows choosing the communication channel that best fits each document. A drawback of the solution described above is that the use of the available communication channels is not completely optimized. Particularly, the proposed method is unable to deal with different internal characteristics of the documents; therefore, a mere portion of the document can cause the use of an inefficient communication channel for the whole document. In addition, the above-mentioned solution is not opaque to the addressee of the document; indeed, the suggested method provides the document to its addressee in different formats (corresponding to the selected communication channel).

### SUMMARY OF THE INVENTION

The present invention proposes a solution, which is based on the idea of using specific communication channels for different portions of the messages.

Particularly, an aspect of the present invention provides a method of transmitting information in a data processing system with distributed architecture. The method starts with the step of requesting the transmission of a message from a source computer to one or more target computers (where a plurality of communication channels are available between the source computer and the target computers). The message is then partitioned into a plurality of segments. Each segment belongs to one of a plurality of predefined categories; each category is associated with a corresponding one of the communication channels. Each segment can now be transmitted to the target computers through the corresponding communication channel.

The solution of the invention optimizes the transmission of the messages.

Indeed, each segment of the message is transmitted through the communication channel that best fits its characteristics.

This avoids overloading the communication channels unnecessarily. Particularly, the use of low-efficient communication channels can be limited to the segments that really need it (whereas the other segments of the same message can be transmitted through more efficient communication channels).

It should be noted that the above-mentioned results are achieved with a procedure that is opaque to the target computers; in other words, each target computer can read the message being completely unaware of the different communication channels that have been used for transmitting its segments.

The preferred embodiments of the invention described in the following provide additional advantages.

For example, the message includes a main body (belonging to a corresponding category) and a set of attachments for the body. In this case, the message is partitioned by determining the category of each attachment. If the category of the attachment differs from the category of the body, a downloading location is assigned to the attachment. The message is then compacted by replacing the attachment with an external link, which points to the corresponding downloading location (with the compacted message that is assigned to the category of the body).

The proposed implementation is very simple and of general applicability; moreover, it allows transmitting the compacted message to the target computers directly.

Advantageously, each target computer receives the compacted message. One or more replaced attachments are selected; those selected replaced attachments are then downloaded (from the location that is pointed by the corresponding external link). It is then possible to reconstruct the message (completely or only partially), by restoring each downloaded attachment in place of the corresponding external link.

This feature makes it possible to reconstruct the message dynamically, with each target computer that is completely unaware of any transformation that may have taken place. Moreover, the compacted message can be transmitted even without moving its attachments (which are downloaded only when it is necessary).

A way to further improve the solution is to associate a condition to one or more replaced attachments. In this case, the target computer verifies each condition associated with the selected replaced attachments. The downloading of the corresponding selected replaced attachment is then prevented if the condition is not satisfied.

This additional function allows sending a common message to different target computers (with each target computer that automatically receives the attachments for its configuration only).

In a preferred embodiment of the invention, the categories are defined according to the size of the segments.

The above-mentioned implementation allows exploiting the available communication channels in a very efficient way.

Particularly, the invention has been specifically designed for a small category and a large category; those categories are defined according to the size of the attachments (with the body that is assigned to the small category). In this case, the small category-is associated with a small-data exchanging connection and the large category is associated with a bulk-data distribution service.

This provides a symmetric and uniform transmission of short messages and bulk data.

As a further enhancement, the bulk-data distribution service includes one or more depot computers (between the downloading location of each replaced attachment and the target computer). In this case, when a selected replaced attachment must be downloaded each depot computer at first verifies whether a copy thereof is available on the depot computer; if so, the copy of the selected replaced attachment is delivered directly.

Therefore, it is possible to avoid repeating the transmission of attachments that are shared by multiple target computers.

A further aspect of the present invention provides a computer program for performing the above-described method.

A still further aspect of the invention provides a program product embodying this computer program.

Moreover, another aspect of the invention provides a corresponding data processing system.

The novel features believed to be characteristic of this invention are set forth in the appended claims. The invention 5 itself, however, as well as these and other related objects and advantages thereof, will be best understood by reference to the following detailed description to be read in conjunction with the accompanying drawings.

### BRIEF DESCRIPTION OF THE DRAWINGS

FIG. 1a is a schematic block diagram of a data processing system in which the method of the invention is applicable;

FIG. 1b shows the functional blocks of a generic computer of the system;

FIG. 2 depicts the main software components that can be used for practicing the method;

FIGS. 3a-3b illustrate a proposed structure of messages used by the method;

FIGS. 4a-4d show a diagram describing the flow of activities relating to an illustrative implementation of the method.

### DETAILED DESCRIPTION OF THE PREFERRED EMBODIMENT(S)

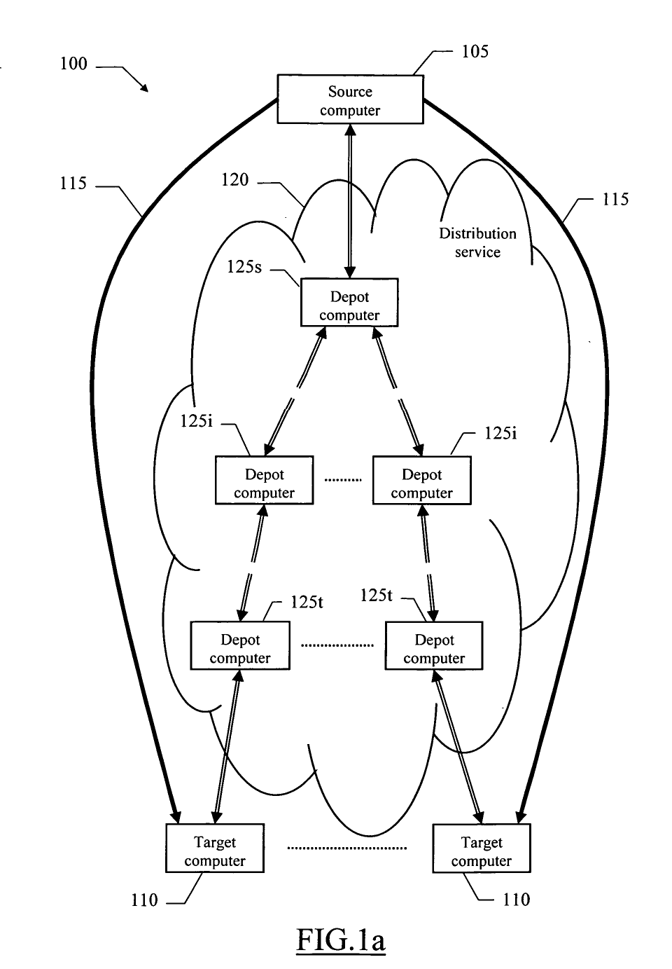

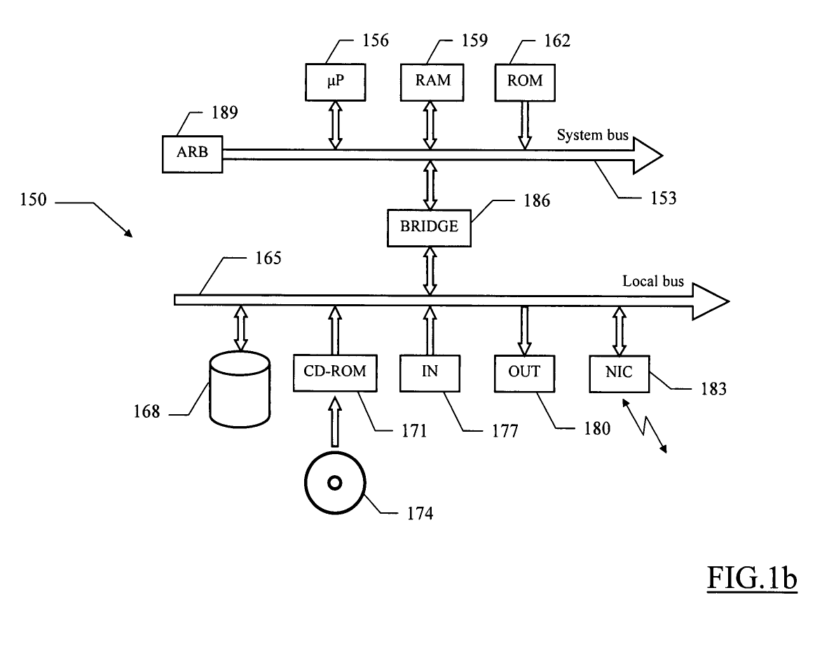

With reference in particular to FIG. 1a, a data 15 processing system 100 with distributed architecture is illustrated. The system includes a source computer 105, which transmits messages to one ore more target computers 110. For this purpose, the source computer 105 communicates with each target computer 110 through a corresponding connection 115; the connection 115 (for example, implemented by means of a web service) is optimized for exchanging small amount of data. In addition, the source computer 105 and the target computers 110 also access a distribution service 120; on the contrary, the distribution service is specifically designed for delivering bulk data.

Preferably, the distribution service 120 is implemented by a hierarchy of gateways, which operate as repeaters (or depots) wherein the information to be distributed is loaded and stored. More in detail, the source computer 105 is associated with a depot computer 125s, whereas each target computer 110 is associated with a corresponding depot computer 125t; one or more levels of intermediate depot computers 125i can be interposed between the depot computer 125s and the depot computers 125t.

As shown in FIG. 1b, a generic computer of the system (source computer, target computer or depot computer) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Peripheral units are clustered around a local bus 165 (by means of respective interfaces). Particularly, a mass memory consists of a hard disk 168 and a drive 171 for reading CD-ROMs 174. Moreover, the computer 150 includes input devices 177 (for example, a keyboard and a mouse), and output devices 180 (for example, a monitor and a printer). A Network Interface Card (NIC) 183 is used to connect the computer 150 to a network. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

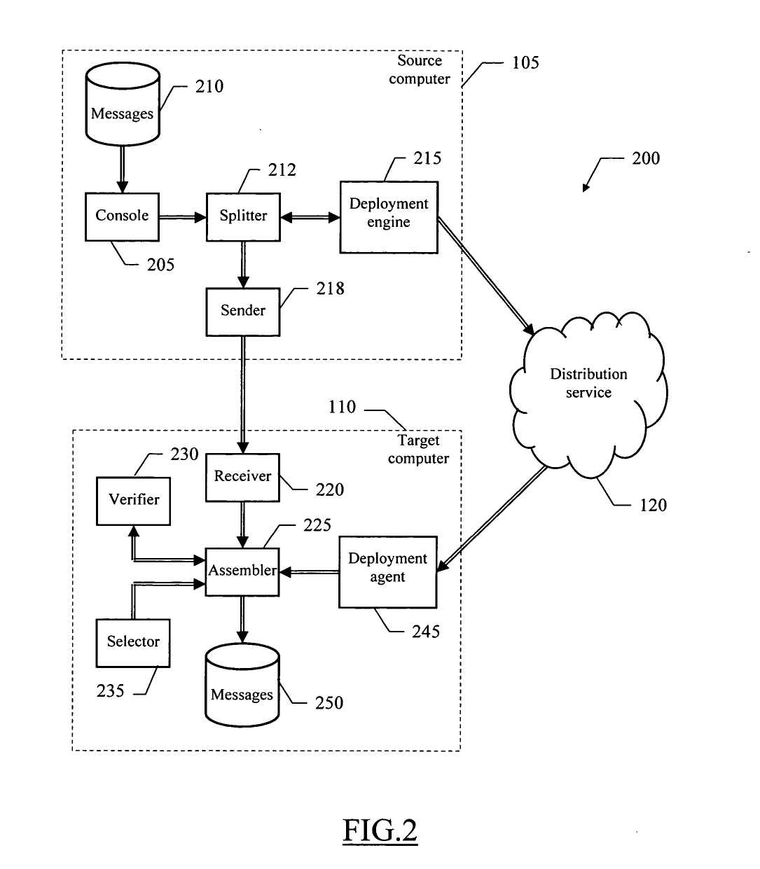

Considering now FIG. 2, the main software components that can be used for practising the invention are denoted as a whole with the reference 200. The information (programs and data) is typically stored on the hard disks and loaded (at least partially) into the corresponding working memories when the programs are running. The programs are initially installed onto the hard disks from CD-ROMs.

Considering in particular the source computer 105, a console 205 is used to submit requests of transmission of generic messages that are retrieved from a corresponding memory structure 210; each message can be specific for a single target computer, can be addressed to a set of selected target computers, or can be broadcast to all the target computers of the system.

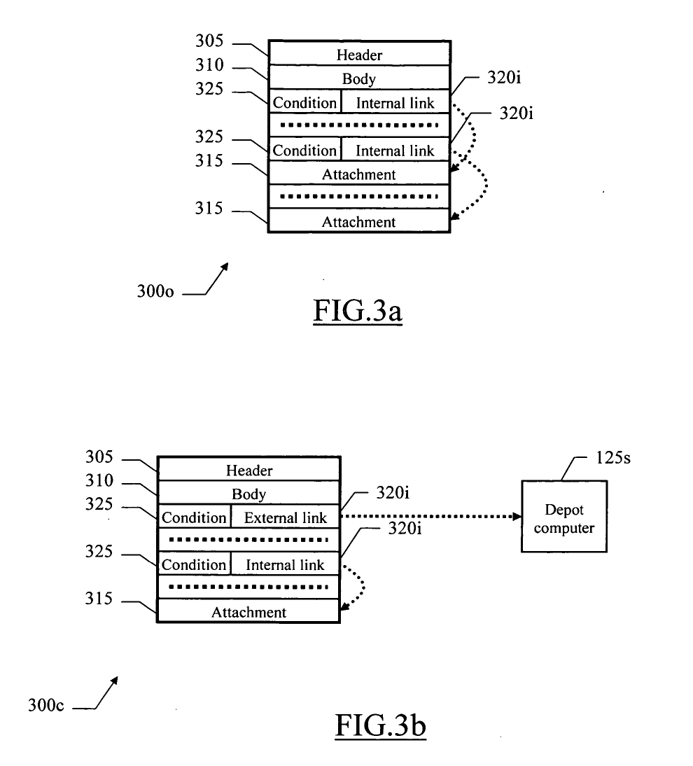

As shown in FIG. 3a, the submitted message (denoted with 300o) starts with a header 305; the header 305 provides control information for the message 300o (for example, its type, size, destination, and the like). A body 310 is used to insert the main information to be conveyed; typically, the body 310 consists of a short text section (for example, of a few Kbytes). One ore more attachments 315 can also be enclosed with the message 300o. The attachments 315 are files including documents, images, multimedia works, executable programs, libraries, and the like; the size of the attachments 315 spans a large range (for example, from some Kbytes to several Mbytes). An internal link 320i points to each attachment 315. A condition expression 325 can also be associated with each attachment 315; the expression 325 defines the condition that must be satisfied on each target computer for enabling the receiving of the corresponding attachment 315. For example, the attachments 315 can consist of different patches of a software product for specific operative environments; in this case, each condition expression 325 specifies an operating system that is required on the target computer for the application of the corresponding patch. The condition expression 325 can also include multiple fields, which are combined with standard logical operators (such as AND, OR, and NOT).

Referring back to FIG. 2, the console 205 controls a splitter 212. The splitter 212 is used to partition each message to be transmitted into multiple segments (according to their size). For this purpose, the splitter 212 accesses a deployment engine 215, which interfaces with the distribution service 120.

More in detail, as shown in FIG. 3b, the splitter verifies the size of each attachment in the message. If the size of the attachment reaches a threshold value (for example, between 100 Kbytes and 2 Mbytes, and preferably between 200 Kbytes and 2 Mbytes, such as 500 Kbytes), the splitter submits a request for uploading the attachment to the associated depot computer 125s of the distribution service. The depot computer 125 assigns and returns a unique identifier of the attachment (which points to a location wherein the attachment will be available for downloading). The splitter then compacts the message by replacing the internal link to the attachment with an external link 315e pointing to its downloading location; at the same time, the attachment is removed from the message. In this way, the compacted message (denoted with 300c) will be reduced to a very small size (as a result of the removal of its bulk data).

Returning to FIG. 2, the compacted message is supplied by the splitter 212 to a sender 218. The sender 218 controls the transmission of the compacted message to the desired target computers (while the corresponding removed attachments are available in the distribution service 120).

Each target computer 110 receives the compacted message by means of a corresponding module 220. The receiver 220 then provides the compacted message to an assembler 225, which reconstructs the original message. For this purpose, the assembler 225 can retrieve all the removed attachments automatically. In this case, the assembler preferably interfaces with a verifier 230, which is used to evaluate the condition expression associated with each external link of the compacted message (pointing to the location of a corresponding removed attachment). Alternatively, the assembler 225 is controlled by a selector 235; the selector 235 allows a user of the target computer 110 to choose the desired removed attachments to be retrieved. In any case, the selected attachments are downloaded from the distribution service 120 through a deployment agent 245 (by using the corresponding external link). Each downloaded attachment is then reinserted into the compacted message; at the same time, the external link to the location of the selected attachment is replaced with a new internal link (that points to the downloaded attachment). The resulting message (including all or only some of the attachments) is then saved into a corresponding memory structure 250.

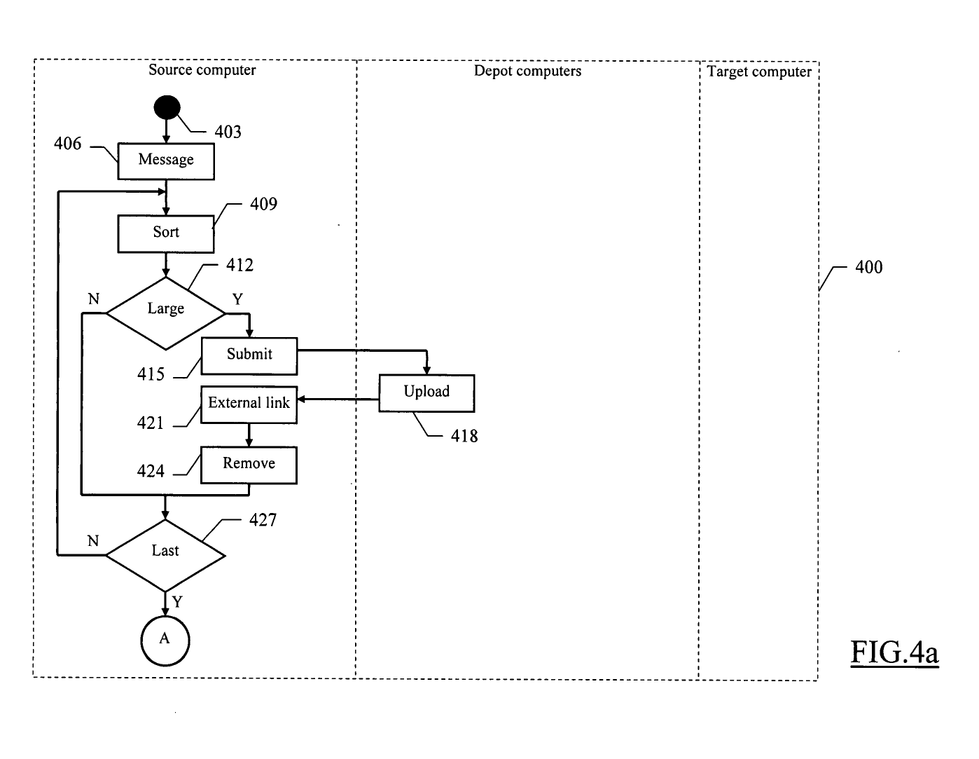

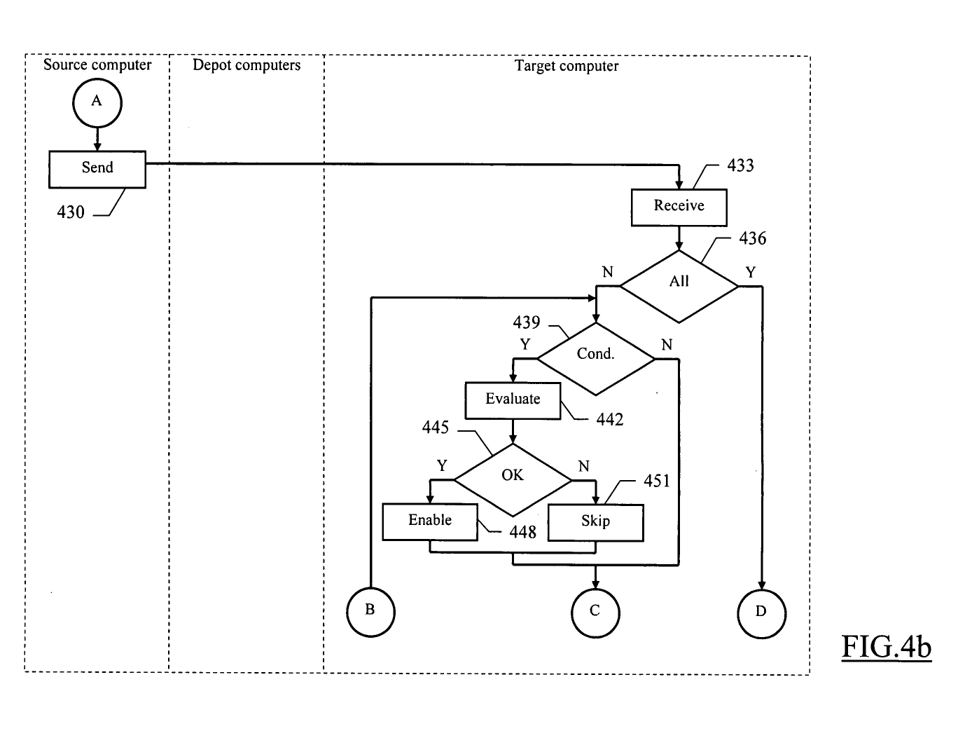

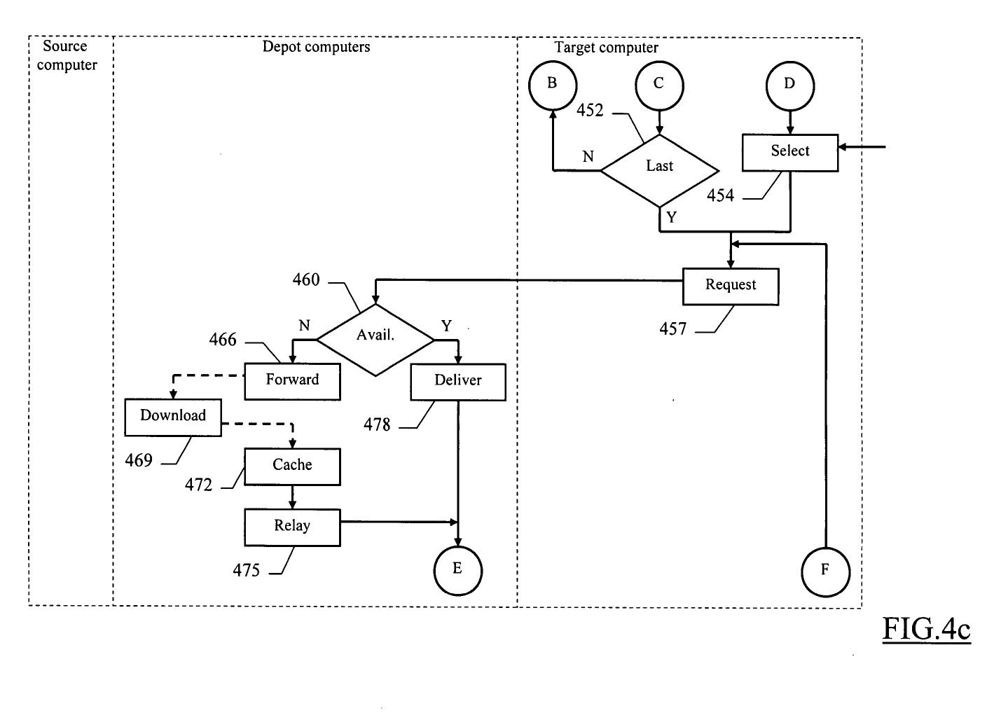

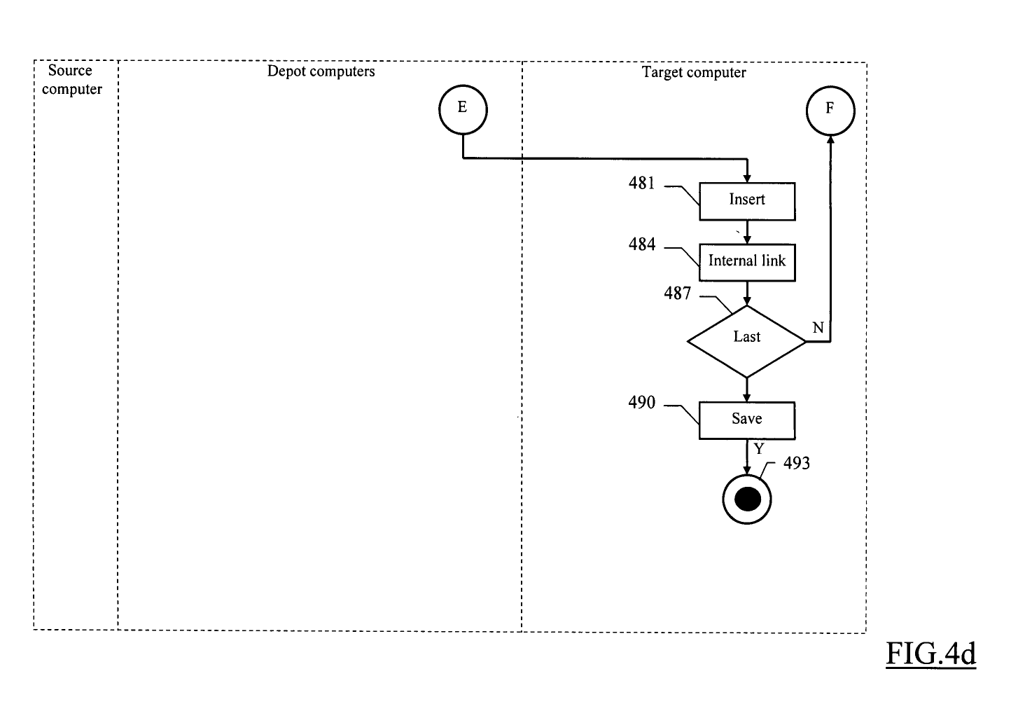

Considering now FIGS. 4a-4d, the logic flow of a transmission process according to an embodiment of the invention is represented with a method 400. The method begins at the black start circle 403 in the swim-lane of the source computer. Continuing to block 406, a request of transmission of a selected message (to one or more desired target computers) is submitted.

A loop is then performed for each attachment of the message (starting from the first one); the loop begins at block 409, wherein the attachment is sorted according to its size; particularly, the attachment is deemed of a small category if its size is lower than the threshold value, whereas it is deemed of a large category otherwise (the attachment can be assigned to either categories when its size is exactly the same as the threshold value).

The flow of activity then branches at decision block 412 according to the category of the attachment. If the attachment is large, a request for uploading the attachment is submitted at block 415 to the depot computer associated with the source computer. In response thereto, this depot computer at block 418 returns the identifier of the downloading location assigned to the attachment. Referring back to the swim-lane of the source computer at block 421, the internal link to the attachment is replaced by the external link pointing to its downloading location. The method continues to block 424, wherein the attachment is removed from the message. The flow of activity then descends into block 427; the same point is also reached directly from block 412 when the attachment is small.

A test is now made at block 427 to determine whether the last attachment of the message has been processed. If not, the method returns to block 409 for repeating the same operations on a next attachment. Once all the attachments have been verified, the method descends into block 430 wherein the compacted message so obtained is transmitted to the desired target computers (through the corresponding small-data exchanging connections).

Each target computer receives the compacted message at block 433. The method then branches at decision block 436. If the target computer is configured to retrieve all the removed attachments automatically, the blocks 439-452 are executed, whereas if the target computer is configured to allow its user to select the desired removed attachments manually the block 454 is executed; In both cases, the method then passes to block 457 (described in the following).

Considering now block 439 (automatic mode), a test is made to determine whether each removed attachment (starting from the first one) is associated with a condition expression. If so, the condition expression is evaluated at block 442; for example, when a specific operating system is required for the removed attachment the condition expression is asserted only if this operating system is installed on the target computer. When the condition expression is satisfied (decision block 445), the retrieval of the removed attachment is enabled at block 448; otherwise, the retrieval of the removed attachment is skipped at block 451 (for example, setting a corresponding flag accordingly). In both cases, the method verifies at block 452 whether the last removed attachment has been processed. If not, the flow of activity returns to block 439 for repeating the same operations on a next removed attachment. Once the condition expressions for all the removed attachments have been verified, the method descends into block 457.

With reference instead to block 439 (manual mode), the user of the target computer can chose the desired removed attachments to be retrieved at block 454; typically, this operation is performed in a completely asynchronous manner (for example, with the user that selects the desired attachments at different times). The flow of activity then descends into block 457.

A loop is now started at block 457; for each selected removed attachment (starting from the first one), a downloading request is submitted to the distribution service (by passing the address of its location specified in the corresponding external link). Particularly, the request is provided to the depot computer associated with the target computer; this depot computer at block 460 verifies whether a copy of the attachment is already available (for example, in its cache memory). If not, the request is forwarded at block 466 to a parent depot computer; the same operations are reiterated until a copy of the attachment is found. Assuming that the attachment is only available on the depot computer associated with the source computer (for example, because it is requested for the first time), the attachment is downloaded at block 469. The attachment is relayed by the depot computers of the distribution service down to the one associated with the target computer. Particularly, each depot computer saves a copy of the attachment at block 472 in its cache memory; the attachment is then forwarded to a child depot computer towards the target computer at block 475. The same operations are repeated until the attachment is received by the target computer at block 481.

Returning to decision block 460, if the copy of the attachment is available on the depot computer associated with the target computer, this copy is directly downloaded at block 478 (and it is received by the target computer at block 481). Similar considerations apply to any other intermediate depot computer (between the target computer and the depot computer associated with the source computer), wherein the copy of the attachment is already available.

With reference now to block 481, the downloaded attachment is reinserted into the compacted message. Continuing to block 484, the external link to the location of the selected attachment is replaced with a new internal link (pointing to the downloaded attachment). A test is now made at block 487 to determine whether the last selected attachment has been processed. If not, the method returns to block 457 for repeating the same operations on a next selected attachment. Once all the selected attachments have been retrieved, the reconstructed message so obtained in saved onto the target computer at block 490. The method then ends at the concentric black/white stop circles 493.

Although the invention has been described above with a certain degree of particularity with reference to preferred embodiment(s) thereof, it should be understood that various changes in the form and details as well as other embodiments are possible. Particularly, it is expressly intended that all combinations of those elements and/or method steps that substantially perform the same function in the same way to achieve the same results are within the scope of the invention.

For example, the solution of the invention leads itself to be used in a system with a different topology, or including computers having another structure or equivalent units.

The same procedure can also be reiterated recursively at intermediate computers (between the source computer and each target computer). In other words, each intermediate computer receiving a segment to be forwarded to the target computer can handle it as a new message (which transmission must be optimized). Particularly, assuming that the segment has the format described in the foregoing (i.e., with a body and internal/external links to further segments), the same operations can be repeated on the basis of the characteristics of the communication channels available between the intermediate computer and the target computer; for example, it is possible to partition the message at the beginning according to a size-based criterion and then to partition its bulk data according to a security-based criterion.

In addition, it is feasible to place the attachments that are removed from the message onto a HTTP server, an FTP server, or any other location suitable for their downloading. At the same time, equivalent formats of the message are contemplated (for example, with the attachments that are identified by means of corresponding tags without any internal links).

Likewise, the condition expressions can be based on different criteria (such as defined by time windows); at the same time, it is possible to manage the conditioning of the attachments in another way (for example, by deleting each external link when the corresponding condition is not satisfied).

The concepts of the present invention can also be extended to different small-data exchanging connections and bulk-data distribution services (for example, only at two levels without any intermediate depot computer).

Similar considerations apply if the threshold value (which is used for discriminating the small category and the large category of the attachments) is defined in another way (even dynamically, for example, according to a current load of the bulk-data distribution service).

In any case, the programs and the corresponding data can be structured in a different way, or additional modules or functions can be provided; moreover, it is possible to distribute the programs in any other computer readable medium (such as a DVD).

Moreover, it will be apparent to those skilled in the art that the additional features providing further advantages are not essential for carrying out the invention, and may be omitted or replaced with different features.

For example, the message can be partitioned into any type of segments; in addition, the immediate transmission of both the compacted message and the removed attachments to the target computers (without placing the removed attachments onto any downloading location) is not excluded.

Likewise, it is possible to reconstruct the original message automatically on each target computer (before making it available to the respective user).

Moreover, an implementation of the invention without any conditioning scheme is contemplated.

Even though in the preceding description reference has been made to the size of the attachments only (for establishing their category), this is not to be intended as a limitation. Indeed, the present invention leads itself to be implemented by sorting the segments into any other categories (even more than two); for example, it is possible to partition the message according to a level of confidentiality of the segments, to their priorities, and the like.

Likewise, other communication channels can be supported (such as a HTTP connection for public information and a SSL connection for sensitive information).

In any case, an implementation of the invention without the possibility of caching the attachments on the depot computers is not excluded.

Alternatively, the programs are pre-loaded onto the corresponding hard disks, are sent to the computers through the network, are broadcast, or more generally are provided in any other form directly loadable into the working memories of the computers.

However, the method according to the present invention leads itself to be carried out with a hardware structure (for example, integrated in chips of semiconductor material), or with a combination of software and hardware.

Naturally, in order to satisfy local and specific requirements, a person skilled in the art may apply to the solution described above many modifications and alterations all of which, however, are included within the scope of protection of the invention as defined by the following claims.

1. A method of transmitting information in a data processing system with distributed architecture, the method including the steps of:
requesting the transmission of a message from a source computer to at least one target computer, a plurality of communication channels being available between the source computer and the at least one target computer, characterized by the steps of partitioning the message into a plurality of segments, wherein each segment belongs to a predefined one of a plurality of categories, each category being associated with a corresponding one of the communication channels, and
transmitting each segment to the at least one target computer through the corresponding communication channel.

2. The method according to claim 1, wherein the message includes a main body belonging to a corresponding category and a set of attachments for the body, for each attachment the step of partitioning the message including:
determining the category of the attachment,
assigning a downloading location to the attachment if the category of the attachment differs from the category of the body, and
compacting the message by replacing the attachment with an external link pointing to the corresponding downloading location, the compacted message being assigned to the category of the body.

3. The method according to claim 2, further including the steps for each target computer of:
receiving the compacted message,
selecting at least one replaced attachment,
downloading the at least one selected replaced attachment from the location pointed by the corresponding external link, and
at least partially reconstructing the message by restoring each downloaded attachment in place of the corresponding external link.

4. The method according to claim 3, wherein at least one replaced attachment is associated with a corresponding condition, for each condition associated with the at least one selected replaced attachment the method further including the steps of:
verifying the condition, and
preventing the downloading of the corresponding selected replaced attachment if the condition is not satisfied.

5. The method according to claim 1, wherein the categories are defined according to the size of the segments.

6. The method according to claim 5, wherein the categories include a small category and a large category defined according to the size of the attachments, the body being assigned to the small category, and wherein the small category is associated with a small-data exchanging connection and the large category is associated with a bulk-data distribution service.

7. The method according to claim 6, wherein the bulk-data distribution service includes at least one depot computer between the downloading location of each replaced attachment and the target computer, for each depot computer the step of downloading each selected replaced attachment including:
verifying an availability of a copy of the selected replaced attachment on the depot computer, and
delivering the copy of the selected replaced attachment if available.

8. A computer program including program code means directly loadable into a working memory of a data processing system for performing the method of claim 1 when the program is run on the system.

9. (canceled)

10. A data processing system with distributed architecture including a source computer, at least one target computer, a plurality of communication channels between the source computer and the at least one target computer, and means for requesting the transmission of a message from the source computer to the at least one target computer, characterized in that
the system further includes means for partitioning the message into a plurality of segments, wherein each segment belongs to a predefined one of a plurality of categories, each category being associated with a corresponding one of the communication channels, and means for transmitting each segment to the at least one target computer through the corresponding communication channel.

11. The product according to claim 8, wherein the message includes a main body belonging to a corresponding category and a set of attachments for the body, including:
instructions for determining the category of the attachment,
instructions for assigning a downloading location to the attachment if the category of the attachment differs from the category of the body, and
instructions for compacting the message by replacing the attachment with an external link pointing to the corresponding downloading location, the compacted message being assigned to the category of the body.

12. The product according to claim 11, further including
instructions for receiving the compacted message,
instructions for selecting at least one replaced attachment,
instructions for downloading the at least one selected replaced attachment from the location pointed by the corresponding external link, and
instructions for at least partially reconstructing the message by restoring each downloaded attachment in place of the corresponding external link.

13. The system according to claim 10, wherein the message includes a main body belonging to a corresponding category and a set of attachments for the body, for each attachment the means for partitioning the message includes:
means for determining the category of the attachment,
means for assigning a downloading location to the attachment if the category of the attachment differs from the category of the body, and
means for compacting the message by replacing the attachment with an external link pointing to the corresponding downloading location, the compacted message being assigned to the category of the body.

14. The system according to claim 13, further including of:
means for receiving the compacted message,
means for selecting at least one replaced attachment,
means for downloading the at least one selected replaced attachment from the location pointed by the corresponding external link, and
means for at least partially reconstructing the message by restoring each downloaded attachment in place of the corresponding external link.
